(19) United States
(12) Patent Application Publication
(10) Pub. No.: US 2006/0031044 A1
(43) Pub. Date: Feb. 9, 2006

(54) Identification of interior design features

(76) Inventors: Bran Ferren, Beverly Hills, CA (US); Edward K. Y. Jung, Bellevue, WA (US); Clarence T. Tegreene, Bellevue, WA (US)

Correspondence Address: Searete LLC;Suite 110, 1756-114th Ave. S.E., Bellevue, WA, 98004, US

(21) Appl. No.: 10/911,819

(22) Filed: Aug. 4, 2004

(51) Int. Cl. G06F 17/50

(52) U.S. Cl. 703/1

(57) ABSTRACT

One embodiment of the subject matter of the present application, a method for identifying features of a model of an interior configuration of one or more three-dimensional objects within a three-dimensional interior space, includes including at least one respective identifier in an interior space item, the interior space item including an interior space cavity, the interior space cavity forming at least a part of a model of the three-dimensional interior space, and in one or more object items, the one or more object items forming at least a part of models of the one or more three-dimensional objects. Other embodiments are also disclosed.

### CROSS-REFERENCE TO RELATED APPLICATIONS

The present application is related to, claims the earliest available effective filing date(s) from (e.g., claims earliest available priority dates for other than provisional patent applications; claims benefits under 35 USC § 119(e) for provisional patent applications), and incorporates by reference in its entirety all subject matter of the following listed application(s); the present application also claims the earliest available effective filing date(s) from, and also incorporates by reference in its entirety all subject matter of any and all parent, grandparent, great-grandparent, etc. applications of the following listed application(s):

1. U.S. patent application entitled EMBEDDED IDENTIFIERS, naming Bran Ferren, Edward K. Y. Jung and Clarence T. Tegreene as inventors, filed 16 Mar. 2004 having U.S. patent application Ser. No. 10/802,106.

2. U.S. patent application entitled A SYSTEM FOR MAKING CUSTOM PROTOTYPES, naming Edward K. Y. Jung, Bran Ferren and Clarence T. Tegreene as inventors, filed 2 Jul. 2004 having U.S. patent application Ser. No. 10/884,760.

3. U.S. patent application entitled PERSONALIZED PROTOTYPING, naming Edward K. Y. Jung, Bran Ferren and Clarence T. Tegreene as inventors, filed 16 Jul. 2004 having U.S. patent application Ser. No. 10/892,974.

4. U.S. patent application entitled CUSTOM PROTOTYPING, naming Edward K. Y. Jung, Bran Ferren and Clarence T. Tegreene as inventors, filed 16 Jul. 2004 having U.S. patent application Ser. No. 10/892,755; and

5. U.S. patent application entitled INTERIOR DESIGN USING RAPID PROTOTYPING, naming Bran Ferren and Clarence T. Tegreene as inventors, filed 30 Jul. 2004.

### TECHNICAL FIELD

The present application relates, in general, to interior design models.

### SUMMARY

One embodiment, a method for identifying features of a model of an interior configuration of at least one three-dimensional object within a three-dimensional interior space, includes but is not limited to including at least one respective identifier (a) in an interior space item, the interior space item including an interior space cavity, the interior space cavity forming at least a part of a model of the three-dimensional interior space, and (b) in at least one object item, the at least one object item forming at least a part of a model of the at least one three-dimensional object. In addition to the foregoing, other method aspects are described in the claims, drawings, and text forming a part of the present application.

In one or more various aspects, related systems include but are not limited to circuitry and/or programming and/or electromechanical components for effecting the herein-referenced method aspects; the circuitry and/or programming and/or electro-mechanical components can be virtually any combination of hardware, software, firmware, and/or electromechanical components configured to effect the herein-referenced method aspects depending upon the design choices of the system designer in light of the teachings herein.

Another embodiment, a system for producing a model of an interior configuration of at least one three-dimensional object within a three-dimensional interior space, includes but is not limited to at least one fabrication apparatus; a processor operably couplable to the at least one fabrication apparatus; a memory operably couplable to the processor and operably couplable to the at least one fabrication apparatus; and software stored in the memory and adapted (a) to associate at least one respective identifier with an interior space item, the interior space item including an interior space cavity, the interior space cavity forming at least a part of a scale model of the three-dimensional interior space, and with at least one object item, the at least one object item forming at least a part of a scale model of the at least one three-dimensional object, (b) to command the at least one fabrication apparatus to fabricate the interior space item to include the at least one respective identifier associated with the interior space item in the interior space item, and (c) to command the at least one fabrication apparatus to fabricate the at least one object item to include the at least one respective identifier associated with the at least one object item in the at least one object item. In addition to the foregoing, other system aspects are described in the claims, drawings, and text forming a part of the present application.

Another embodiment, a model of an interior configuration of at least one three-dimensional object within a three-dimensional interior space, includes but is not limited to an interior space item including an interior space cavity, the interior space cavity forming at least a part of a scale model of the three-dimensional interior space; and at least one object item, the at least one object item forming at least a part of a scale model of the at least one three-dimensional object; wherein at least one of the interior space item or the at least one object item includes at least one respective identifier. In addition to the foregoing, other model aspects are described in the claims, drawings, and text forming a part of the present application

Other embodiments are described in the detailed descriptions of the figures. In addition to the foregoing, various other method and/or system and/or article aspects are set forth and described in the text (e.g., claims and/or detailed description) and/or drawings of the present application.

The foregoing is a summary and thus contains, by necessity, simplifications, generalizations and omissions of detail; consequently, those skilled in the art will appreciate that the summary is illustrative only and is NOT intended to be in any way limiting. Other aspects, inventive features, and advantages of the devices and/or processes described herein, as defined solely by the claims, will become apparent in the detailed description set forth herein.

### BRIEF DESCRIPTION OF THE FIGURES

FIG. 1 is a flow chart depicting an embodiment of the subject matter of the present application;

FIG. 2 is a flow chart depicting another embodiment of the subject matter of the present application;

FIG. 3 is a flow chart depicting another embodiment;

FIG. 4 is a flow chart depicting another embodiment;

FIG. 5 is a flow chart depicting another embodiment;

FIG. 6 is a flow chart depicting another embodiment;

FIG. 7 is a flow chart depicting another embodiment;

FIG. 8 is a flow chart depicting another embodiment;

FIG. 9 is a flow chart depicting another embodiment;

FIG. 10 is a flow chart depicting another embodiment;

FIG. 11 is a flow chart depicting another embodiment;

FIG. 12 is a flow chart depicting another embodiment;

FIG. 13 is a flow chart depicting another embodiment;

FIG. 14 is a flow chart depicting another embodiment;

FIG. 15 is a flow chart depicting another embodiment;

FIG. 16 is a block diagram depicting another embodiment; and

FIG. 17 is a schematic diagram depicting another embodiment.

The use of the same symbols in different drawings typically indicates similar or identical items.

### DETAILED DESCRIPTION

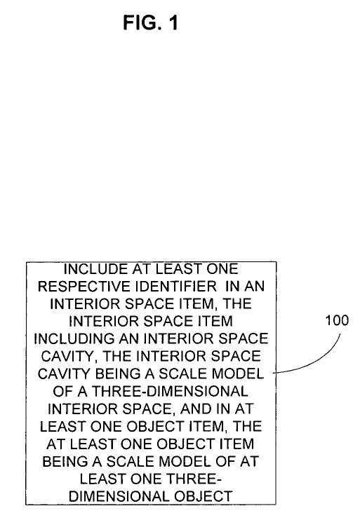

FIG. 1 shows a method for identifying features of a scale model of an interior configuration of one or more three-dimensional objects within a three-dimensional interior space which includes including at least one respective identifier in an interior space item, the interior space item including an interior space cavity, the interior space cavity forming at least a part of a scale model of the three-dimensional interior space, and in one or more object items, the one or more object items forming at least a part of scale models of the one or more three-dimensional objects (step 100). In some implementations, at least a part of the model(s) is to scale, while in other implementations at least a part of the model(s) is not to scale.

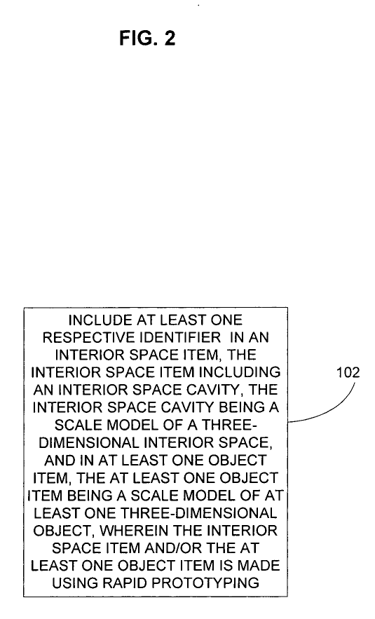

FIG. 2 illustrates another embodiment that includes step 102, including at least one respective identifier in an interior space item, the interior space item including an interior space cavity, the interior space cavity forming at least a part of a scale model of the three-dimensional interior space, and in one or more object items, the one or more object items forming at least a part of scale models of the one or more three-dimensional objects, wherein either the interior space item and/or the one or more object items are made using rapid prototyping.

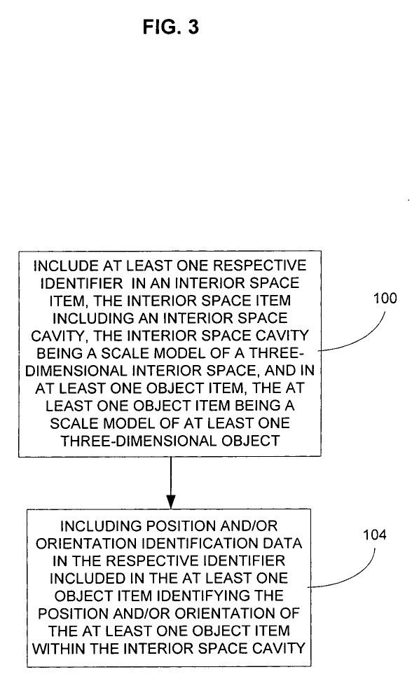

In FIG. 3, another embodiment is depicted, the embodiment including step 100 as described above and, in addition, step 104: including either position identification data, orientation identification data, or both, in the respective identifier included in the one or more object items identifying the position, orientation, or both, of the one or more object items within the interior space cavity.

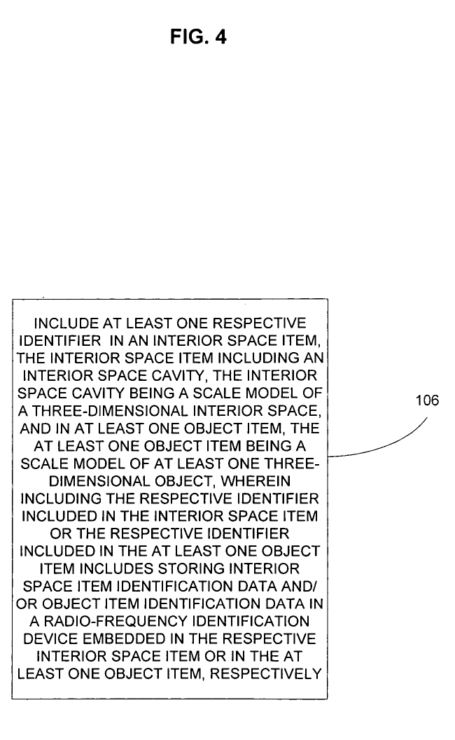

FIG. 4 shows another embodiment, a method for identifying features of a scale model of an interior configuration of one or more three-dimensional objects within a three-dimensional interior space which includes including at least one respective identifier in an interior space item, the interior space item including an interior space cavity, the interior space cavity forming at least a part of a scale model of the three-dimensional interior space, and in one or more object items, the one or more object items forming at least a part of scale models of the one or more three-dimensional objects, in which the including the respective identifier included in the interior space item or the respective identifiers included in the one or more object items includes storing interior space data or object identification data in a radio-frequency identification device (“RFID”) embedded in the interior space item or in the one or more object items, respectively (step 106). Generally, RFIDs are devices that respond with identifying EM radiation when irradiated with particular EM radiation.

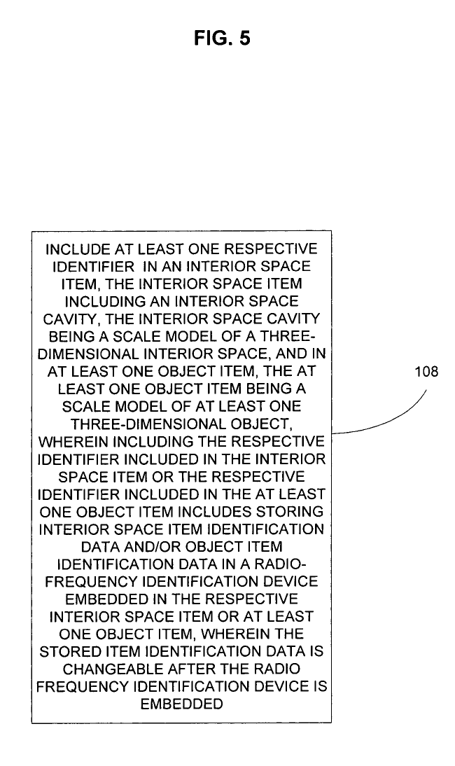

FIG. 5 illustrates an embodiment, a method for identifying features of a scale model of an interior configuration of one or more three-dimensional objects within a three-dimensional interior space which includes including at least one respective identifier in an interior space item, the interior space item including an interior space cavity, the interior space cavity forming at least a part of a scale model of the three-dimensional interior space, and in one or more object items, the one or more object items forming at least a part of scale models of the one or more three-dimensional objects, in which the including the respective identifier included in the interior space item or the respective identifiers included in the one or more object items includes storing interior space data or object identification data in an RFID embedded in the interior space item or in the one or more object items, respectively, and further, in which the interior space or object identification data stored in the RFID is changeable after the RFID is embedded in the interior space item or the one or more object items, respectively (step 108).

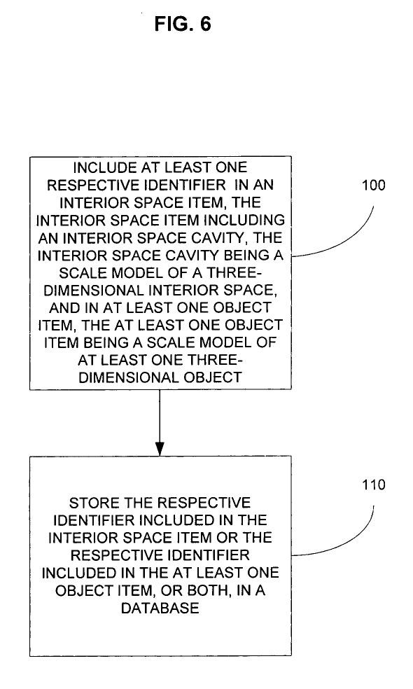

FIG. 6 depicts an embodiment including step 100 and a further step 110, storing the respective identifier included in the interior space item, the respective identifier included in the one or more object items, or both, in a database.

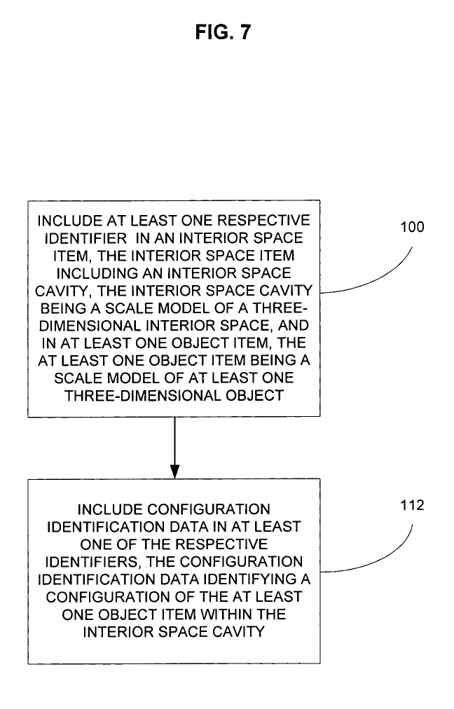

In FIG. 7, an embodiment is illustrated that includes step 100 as described above and a further step 112, including configuration identification data in one or more of the respective identifiers identifying a configuration of the one or more object items within the interior space cavity.

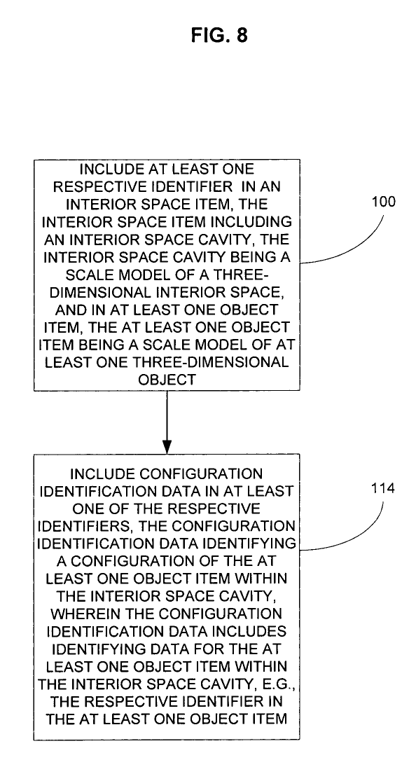

FIG. 8 shows an embodiment including step 100 as described above and, in addition, a further step 114 of including configuration identification data in one or more of the respective identifiers identifying a configuration of the one or more object items within the interior space cavity, in which the configuration identification data includes identifying data for the one or more object items within the interior space cavity, e.g., the respective identifier included in the one or more objects items (step 114).

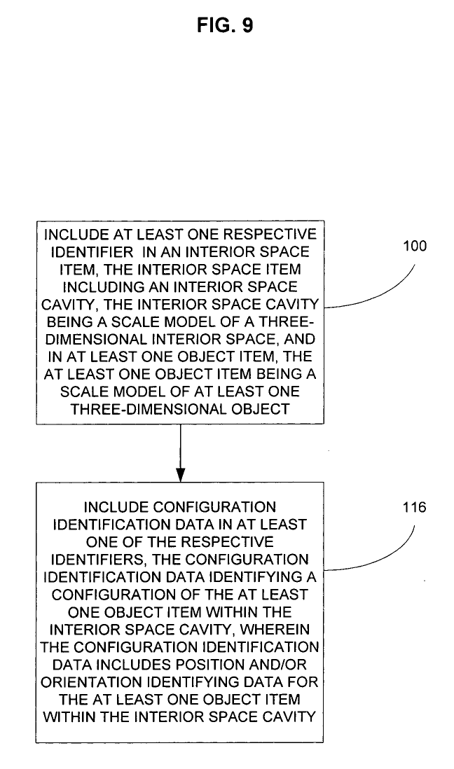

FIG. 9 depicts an embodiment including step 100 as described above and a further step 116 of including configuration identification data in one or more of the respective identifiers identifying a configuration of the one or more object items within the interior space cavity, in which the configuration identification data includes position identifying data, orientation identifying data, or both, for the one or more object items within the interior space cavity (step 116).

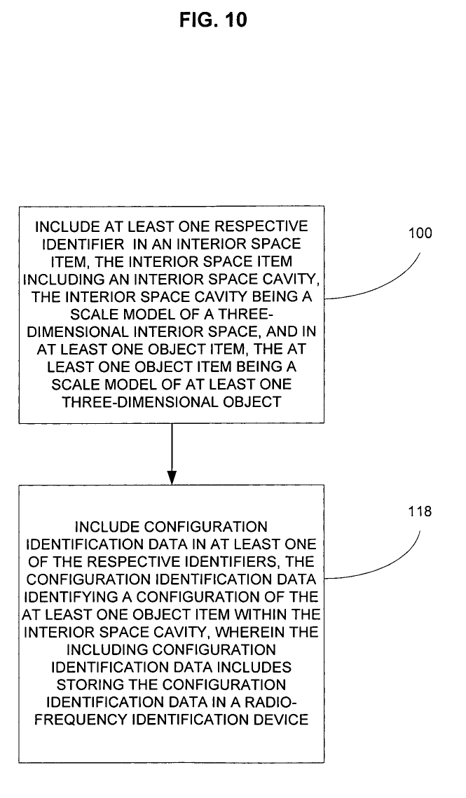

FIG. 10 shows an embodiment that includes step 100 as described above and a further step 118 of including configuration identification data in one or more of the respective identifiers identifying a configuration of the one or more object items within the interior space cavity, in which the including configuration identification data includes storing the configuration identification data in an RFID (step 118).

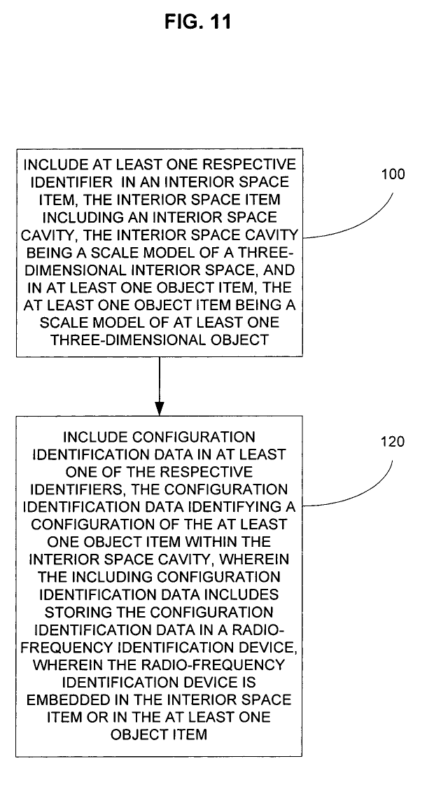

FIG. 11 illustrates an embodiment that includes step 100 as described above and an additional step 120 of including configuration identification data in one or more of the respective identifiers identifying a configuration of the one or more object items within the interior space cavity, in which the including configuration identification data includes storing the configuration identification data in an RFID, and in which the RFID is embedded in the interior space item or in one or more object items (step 120).

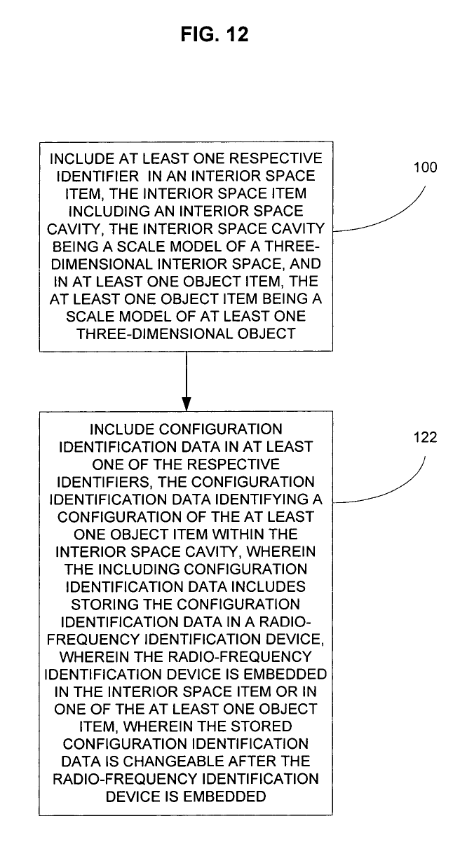

FIG. 12 illustrates an embodiment that includes step 100 as described above and an additional step 122 of including configuration identification data in one or more of the respective identifiers identifying a configuration of the one or more object items within the interior space cavity, in which the including configuration identification data includes storing the configuration identification data in an RFID, in which the RFID is embedded in the interior space item or in one of the one or more object items, and in which the configuration identification data stored in the RFID is changeable after RFID is embedded in the interior space item or in the one or more object items (step 122).

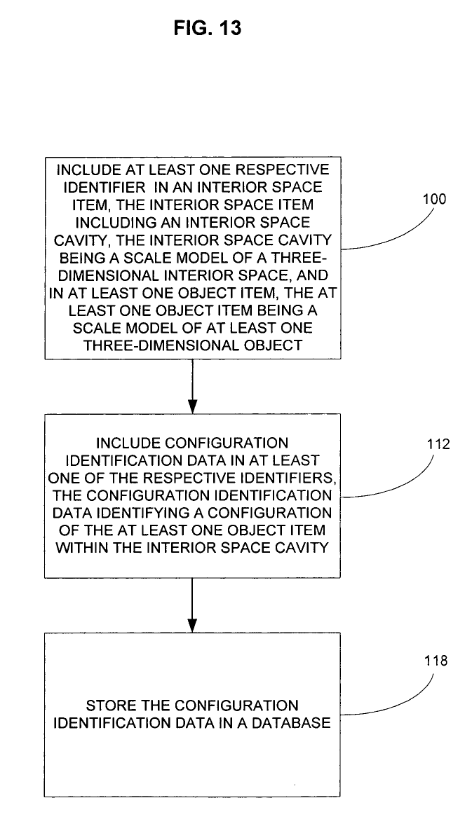

FIG. 13 depicts an embodiment including steps 100 and 112 as described above and further including step 124, storing the configuration identification data in a database.

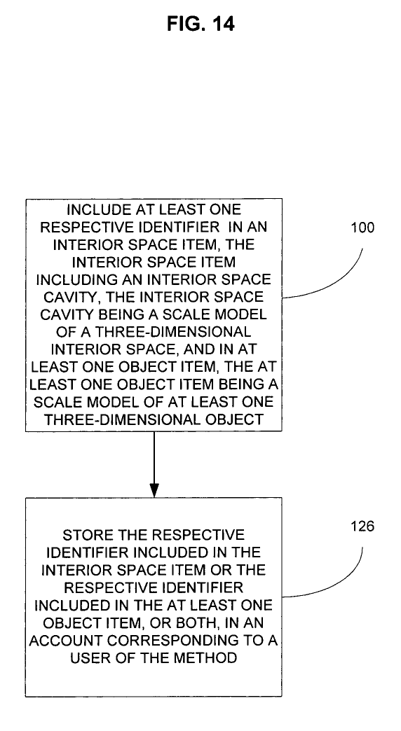

In FIG. 14, an embodiment is shown that includes step 100 as described above and a further step 126 of storing the respective identifiers included in the interior space item and in the one or more object items in an account corresponding to a user of the method (step 126).

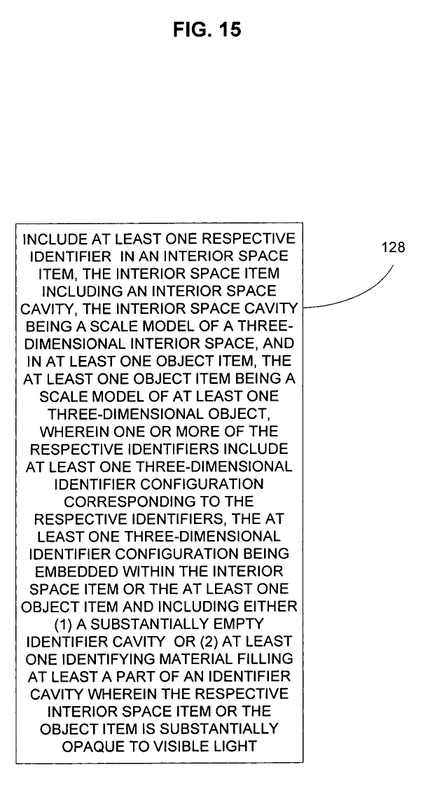

FIG. 15 shows an embodiment, a method for identifying features of a scale model of an interior configuration of one or more three-dimensional objects within a three-dimensional interior space which includes step 128 of including at least one respective identifier in an interior space item, the interior space item including an interior space cavity, the interior space cavity forming at least a part of a scale model of the three-dimensional interior space, and in one or more object items, the one or more object items forming at least a part of scale models of the one or more three-dimensional objects, in which one or more of the respective identifiers include one or more three-dimensional identifier configurations corresponding to the one or more of the respective identifiers, the one or more three-dimensional identifier configurations being embedded and including either (1) a substantially empty identifier cavity, (2) one or more identifying materials filling at least part of an identifier cavity; or (3) one or more identifying materials coating at least a part of an interior surface of an identifier cavity; wherein material surrounding the identifier cavity is substantially opaque to visible light (step 128).

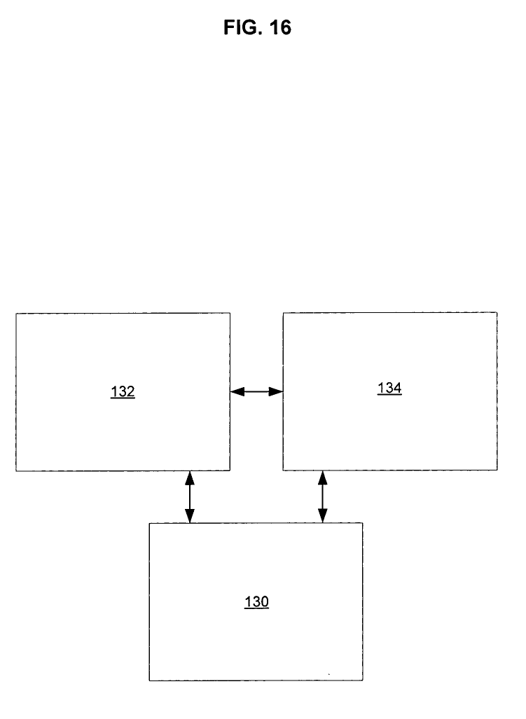

In FIG. 16, a system embodiment for producing a scale model of an interior configuration of at least one three-dimensional object within a three-dimensional interior space is pictured. The pictured embodiment includes one or more fabrication apparatuses 130; a processor 132 operably coupled to the one or more fabrication apparatuses 130; a memory 134 operably coupled to the processor 132 and operably coupled to the one or more fabrication apparatuses 130; and software (not shown) stored in the memory 134 and adapted (1) to associate at least one respective identifier with an interior space item, the interior space item including an interior space cavity, the interior space cavity at least partially constituting a scale model of the three-dimensional interior space, and with one or more object items, the one or more object items at least partially constituting scale models of the one or more three-dimensional objects, (2) to command the one or more fabrication apparatuses 130 to fabricate the interior space item to include the interior space identifier associated with the interior space item in the interior space item, and (3) to command the one or more fabrication apparatuses 130 to fabricate the one or more object items to include the respective object identifier associated with the one or more object items in the one or more object items. Another embodiment includes the one or more fabrication apparatuses 130, the processor 132, the memory 134, and the software described in connection with FIG. 16, and, in addition, software stored in the memory 134 and adapted to store in a database (not shown) a representation of the respective identifier associated with the interior space item and to store in the database a representation of the respective identifier associated with the at least one object item. Yet another embodiment of the system includes the one or more fabrication apparatuses 130, the processor 132, the memory 134, and the software described in connection with FIG. 16, in which the one or more fabrication apparatuses 130 are rapid prototyping apparatuses. (This embodiment may be implemented, e.g., using at least in part a suitably programmed and equipped computer system.)

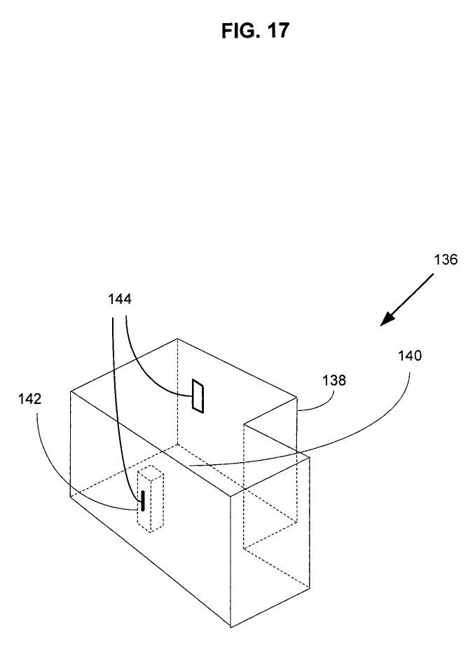

FIG. 17 illustrates a scale model 136 of an interior configuration of one or more three-dimensional objects within a three-dimensional interior space, the scale model including an interior space item 138 including an interior space cavity 140, the interior space cavity 140 at least partially constituting a scale model of the three-dimensional interior space, and one or more object items 142, the one or more object items 142 at least partially constituting scale models of the one or more three-dimensional objects, in which the interior space item 138 and the one or more object items 142 include respective identifiers 144.

One skilled in the art will recognize that the foregoing components (e.g., steps), devices, and objects in FIGS. 1-17 and the discussion accompanying them are used as examples for the sake of conceptual clarity and that various configuration modifications are common. Consequently, as used herein, the specific exemplars set forth in FIGS. 1-17 and the accompanying discussion are intended to be representative of their more general classes. In general, use of any specific exemplar herein is also intended to be representative of its class, and the non-inclusion of such specific components (e.g., steps), devices, and objects herein should not be taken as indicating that limitation is desired.

Those skilled in the art will appreciate that the foregoing specific exemplary processes and/or devices and/or technologies are representative of more general processes and/or devices and/or technologies taught elsewhere herein, such as in the claims filed herewith and/or elsewhere in the present application.

Those having skill in the art will recognize that the state of the art has progressed to the point where there is little distinction left between hardware and software implementations of aspects of systems; the use of hardware or software is generally (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will require optically-oriented hardware, software, and or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in standard integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter subject matter described herein are capable of being distributed as a program product in a variety of forms, and that an illustrative embodiment of the subject matter subject matter described herein applies equally regardless of the particular type of signal bearing media used to actually carry out the distribution. Examples of a signal bearing media include, but are not limited to, the following: recordable type media such as floppy disks, hard disk drives, CD ROMs, digital tape, and computer memory; and transmission type media such as digital and analog communication links using TDM or IP based communication links (e.g., packet links).

In a general sense, those skilled in the art will recognize that the various embodiments described herein can be implemented, individually and/or collectively, by various types of electromechanical systems having a wide range of electrical components such as hardware, software, firmware, or virtually any combination thereof; and a wide range of components that may impart mechanical force or motion such as rigid bodies, spring or torsional bodies, hydraulics, and electro-magnetically actuated devices, or virtually any combination thereof. Consequently, as used herein “electro-mechanical system” includes, but is not limited to, electrical circuitry operably coupled with a transducer (e.g., an actuator, a motor, a piezoelectric crystal, etc.), electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of random access memory), electrical circuitry forming a communications device (e.g., a modem, communications switch, or optical-electrical equipment), and any non-electrical analog thereto, such as optical or other analogs. Those skilled in the art will also appreciate that examples of electromechanical systems include but are not limited to a variety of consumer electronics systems, as well as other systems such as motorized transport systems, factory automation systems, security systems, and communication/computing systems. Those skilled in the art will recognize that electromechanical as used herein is not necessarily limited to a system that has both electrical and mechanical actuation except as context may dictate otherwise.

In a general sense, those skilled in the art will recognize that the various aspects described herein which can be implemented, individually and/or collectively, by a wide range of hardware, software, firmware, or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of random access memory), and electrical circuitry forming a communications device (e.g., a modem, communications switch, or optical-electrical equipment).

All of the above U.S. patents, U.S. patent application publications, U.S. patent applications, foreign patents, foreign patent applications and non-patent publications referred to in this specification and/or listed in any Application Data Sheetare incorporated herein by reference, in their entireties.

The herein described aspects depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and wirelessly interactable and/or wirelessly interacting components.

While particular aspects of the present subject matter described herein have been shown and described, it will be apparent to those skilled in the art that, based upon the teachings herein, changes and modifications may be made without departing from this subject matter described herein and its broader aspects and, therefore, the appended claims are to encompass within their scope all such changes and modifications as are within the true spirit and scope of this subject matter described herein. Furthermore, it is to be understood that the invention is solely defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). Other embodiments are within the following claims.

We claim:

1. A method for identifying features of a model of an interior configuration of at least one three-dimensional object within a three-dimensional interior space, the method comprising:
including at least one respective identifier
in an interior space item, the interior space item including an interior space cavity, the interior space cavity forming at least a part of a model of the three-dimensional interior space, and
in at least one object item, the at least one object item forming at least a part of a model of the at least one three-dimensional object.

2. The method of claim 1, wherein the interior space item is made using rapid prototyping.

3. The method of claim 1, wherein the at least one object item is made using rapid prototyping.

4. The method of claim 1, further comprising:
including position identification data in the at least one respective identifier included in the at least one object item identifying the position of the at least one object item within the interior space cavity.

5. The method of claim 1, further comprising:
including orientation identification data in the at least one respective identifier included in the at least one object item identifying the orientation of the at least one object item within the interior space cavity.

6. The method of claim 1, further comprising:
including combined position and orientation identification data in the at least one respective identifier included in the at least one object item identifying the position and orientation of the at least one object item within the interior space cavity.

7. The method of claim 1, wherein the including the at least one respective identifier included in the interior space item further comprises:
storing interior space identification data in a radio-frequency identification device embedded in the interior space item.

8. The method of claim 7, wherein the interior space identification data stored in the radio-frequency identification device is changeable after the radio-frequency identification device is embedded in the interior space item.

9. The method of claim 1, further comprising:
storing the at least one respective identifier included in the interior space item in a database.

10. The method of claim 1, wherein the including the at least one respective identifier included in the at least one object item further comprises:
storing object identification data in a radio-frequency identification device embedded in the at least one object item.

11. The method of claim 10, wherein the object identification data stored in the radio-frequency identification device is changeable after the radio-frequency identification device is embedded in the at least one object item.

12. The method of claim 1, further comprising:
storing the at least one respective identifier included in the at least one object item in a database.

13. The method of claim 1, further comprising:
including configuration identification data in the at least one respective identifier identifying a configuration of the at least one object item within the interior space cavity.

14. The method of claim 13, wherein the configuration identification data includes identifying data for the at least one object item within the interior space cavity.

15. The method of claim 14, wherein the identifying data for the at least one object item within the interior space cavity includes the at least one respective identifier included in the at least one object item.

16. The method of claim 13, wherein the configuration identification data includes position identifying data for the at least one object item within the interior space cavity.

17. The method of claim 13, wherein the configuration identification data includes orientation identifying data for the at least one object item within the interior space cavity.

18. The method of claim 13, wherein the configuration identification data includes combined position and orientation identifying data for the at least one object item within the interior space cavity.

19. The method of claim 13, wherein the including configuration identification data further comprises:
storing the configuration identification data in a radio-frequency identification device.

20. The method of claim 19, wherein the radio-frequency identification device is embedded in the interior space item.

21. The method of claim 20, wherein the configuration identification data stored in the radio-frequency identification device is changeable after the radio-frequency identification device is embedded in the interior space item.

22. The method of claim 20, wherein the radio-frequency identification device is embedded in the at least one object item.

23. The method of claim 22, wherein configuration identification data stored in the radio-frequency identification device is changeable after the radio-frequency identification device is embedded in the at least one object item.

24. The method of claim 13, further comprising:
storing the configuration identification data in a database.

25. The method of claim 1, further comprising:
storing the at least one respective identifier included in the interior space item in an account corresponding to a user of the method.

26. The method of claim 1, further comprising:
storing the at least one respective identifier included in the at least one object item in an account corresponding to a user of the method.

27. The method of claim 1, wherein the at least one respective identifier comprises:
at least one three-dimensional identifier configuration corresponding to the at least one of the respective identifiers, the at least one three-dimensional identifier configuration being embedded and including either
(1) a substantially empty identifier cavity, or
(2) at least one identifying material filling at least part of an identifier cavity, wherein material surrounding the identifier cavity is substantially opaque to visible light.

28. A system for producing a model of an interior configuration of at least one three-dimensional object within a three-dimensional interior space, the system comprising:
at least one fabrication apparatus;
a processor operably couplable to the at least one fabrication apparatus;
a memory operably couplable to the processor and operably couplable to the at least one fabrication apparatus; and
software stored in the memory and adapted
to associate at least one respective identifier with an interior space item, the interior space item including an interior space cavity, the interior space cavity forming at least a part of a scale model of the three-dimensional interior space, and with at least one object item, the at least one object item forming at least a part of a scale model of the at least one three-dimensional object,
to command the at least one fabrication apparatus to fabricate the interior space item to include the at least one respective identifier associated with the interior space item in the interior space item, and
to command the at least one fabrication apparatus to fabricate the at least one object item to include the at least one respective identifier associated with the at least one object item in the at least one object item.

29. The system of claim 28, further comprising software stored in the memory and adapted to store in a database a representation of the at least one respective identifier associated with the interior space item and to store in the database a representation of the at least one respective identifier associated with the at least one object item.

30. The system of claim 28, wherein the at least one fabrication apparatus is a rapid prototyping apparatus.

31. A model of an interior configuration of at least one three-dimensional object within a three-dimensional interior space, the model comprising:
an interior space item including an interior space cavity, the interior space cavity forming at least a part of a scale model of the three-dimensional interior space;
at least one object item, the at least one object item forming at least a part of a scale model of the at least one three-dimensional object; and
wherein at least one of the interior space item or the at least one object item includes at least one respective identifier.

32. The model of claim 31, wherein the model is manufactured using rapid prototyping.

33. The model of claim 31, wherein the model is a scale model.
